(19) United States
(12) Patent Application Publication
(10) Pub. No.: US 2024/0336466 A1
(43) Pub. Date: Oct. 10, 2024

(54) TELESCOPIC ARM FOR SELF-PROPELLED OPERATING MACHINES

(71) Applicant: MANITOU ITALIA S.R.L., CASTELFRANCO EMILIA (MODENA) (IT)

(72) Inventor: MARCO IOTTI, REGGIO EMILIA (IT)

(21) Appl. No.: 18/621,780

(22) Filed: Mar. 29, 2024

(30) Foreign Application Priority Data
Apr. 4, 2023 (IT) 102023000006594

(51) Int. Cl. B66F 9/22; B66F 9/065; B66F 9/075; F15B 13/06; F15B 15/16

(52) U.S. Cl. CPC B66F 9/22; B66F 9/0655; B66F 9/0755; F15B 13/06; F15B 15/16

(57) ABSTRACT

Described is a telescopic lifting arm (1) for self-propelled operating machines (10) comprising three tubular elements (21, 22, 23, 24, 25, 26), with a decreasing cross-section and telescopically connected to each other to define a supporting structure, designed to move between a retracted configuration wherein said tubular elements (21, 22, 23, 24, 25, 26) are inserted one in the other and an elongated configuration wherein two tubular elements are partly extracted. The arm (1) comprises actuator means (5) associated with the tubular elements (21, 22, 23, 24, 25, 26) and configured for actuating two tubular elements (21, 22, 23, 24 25, 26) for pulling them out independently from one other and with different speeds.

This invention relates to a telescopic arm for self-propelled operating machines.

More in detail, the arm according to the invention may be used in any type of operating machine such as, for example, telehandlers, manipulators, lift trucks, aerial platforms, both of the fixed type and of the rotary type.

These operating machines are used in various sectors, from building works, to farming, to mining, etc. and may, for example, consist of telehandlers which include a vehicle provided with a frame movable on tracks or on wheels, which mounts the driver's cab and a lifting arm which can be extended telescopically.

At the distal end of the arm there is an apparatus, or “accessory”, for lifting or moving loads, which comprises a tool such as a fork, a gripper, etc.

The arm is articulated to the frame or to a rotary platform of the machine and is designed to incline between a lower position, substantially horizontal, to an upper position wherein the arm is close to the vertical; the inclination is actuated by hydraulic cylinders or the like.

The arm comprises a plurality of sliding segments, tubular in shape and with a decreasing cross-section, which are connected in a telescopic fashion.

The use is known of a system of chain type linkage devices which connects the first sliding member to the successive inner ones, configured so that the extraction or return stroke to which the first sliding member is subjected, under the actuation of a hydraulic cylinder, is also transmitted to the other sliding members.

The last sliding segment is connected to a work tool, such as, for example, forks, grippers, hooks or the like.

The greater the lifting heights which the arm must reach, the greater must be the number of sliding members to be used.

Consequently, an increase in the number of sliding members or of the load which the arm must support is followed by an increase in the mechanical stresses to the overall structure of the arm.

In effect, the increase in the load and/or the extension is limited by the consequent reduction in the functional mechanical strength of the arm.

Disadvantageously, acting on the material and/or on the thickness with which the telescopic arms are made would result in an increase in weight of the overall machine and a considerable increase in costs.

This circumstance constitutes a limit to the height to which the prior art arms can carry the loads lifted, beyond a constraint to the maximum permitted extension and the maximum load which can be moved.

The technical purpose of the invention is therefore to provide a telescopic arm for self-propelled operating machines which is able to overcome the drawbacks of the prior art.

The technical purpose indicated and the aims specified are substantially achieved by a telescopic arm for self-propelled operating machines comprising the technical features described in one or more of the appended claims. The dependent claims correspond to possible embodiments of the invention.

Further features and advantages of the invention are more apparent in the non-limiting description which follows of a non-exclusive embodiment of a telescopic arm for self-propelled operating machines. The description is set out below with reference to the accompanying drawings which are provided solely for purposes of illustration without restricting the scope of the invention and in which:

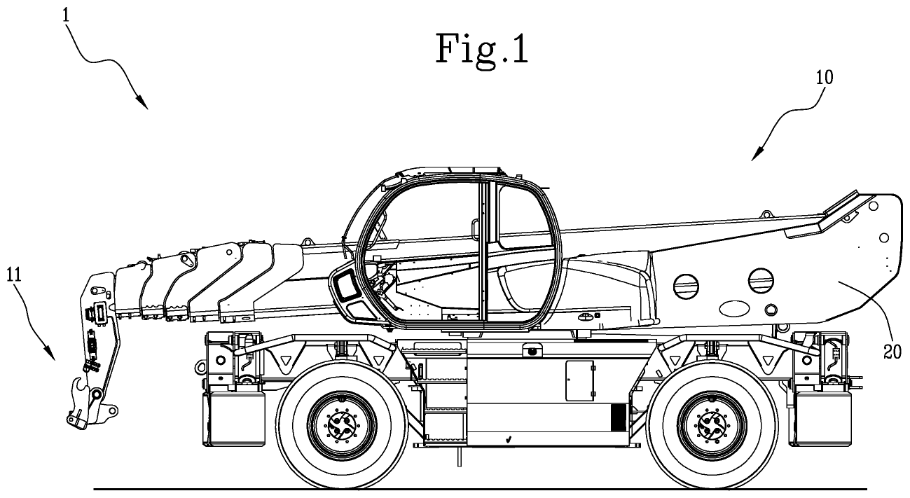

FIG. 1 is a side view of an operating machine which mounts the arm according to the invention;

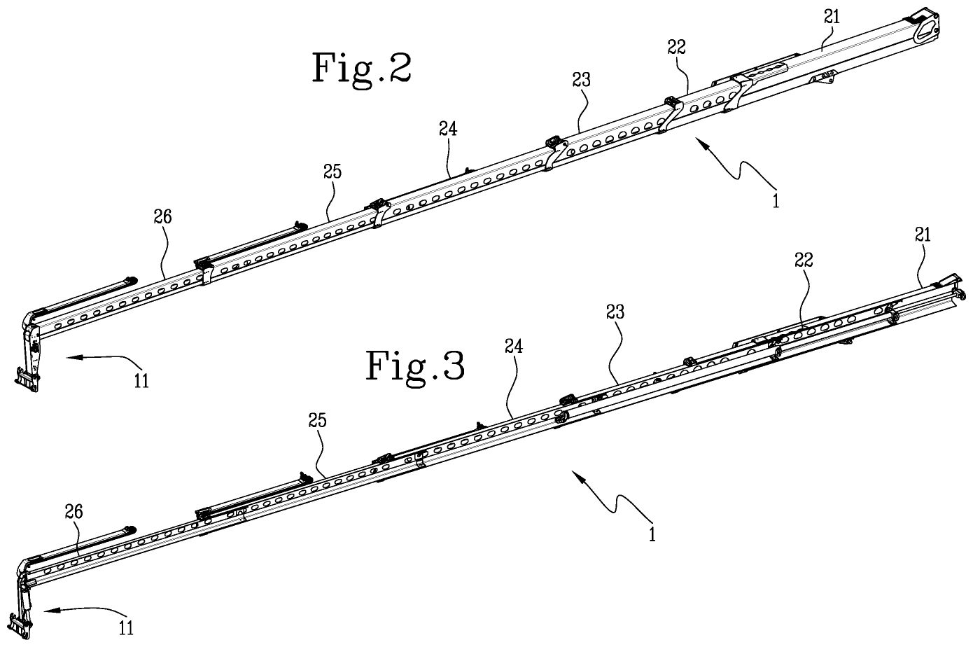

FIG. 2 is an axonometric view of the arm according to the invention, in a partly extracted configuration;

FIG. 3 is a cross section view of the arm shown in FIG. 2;

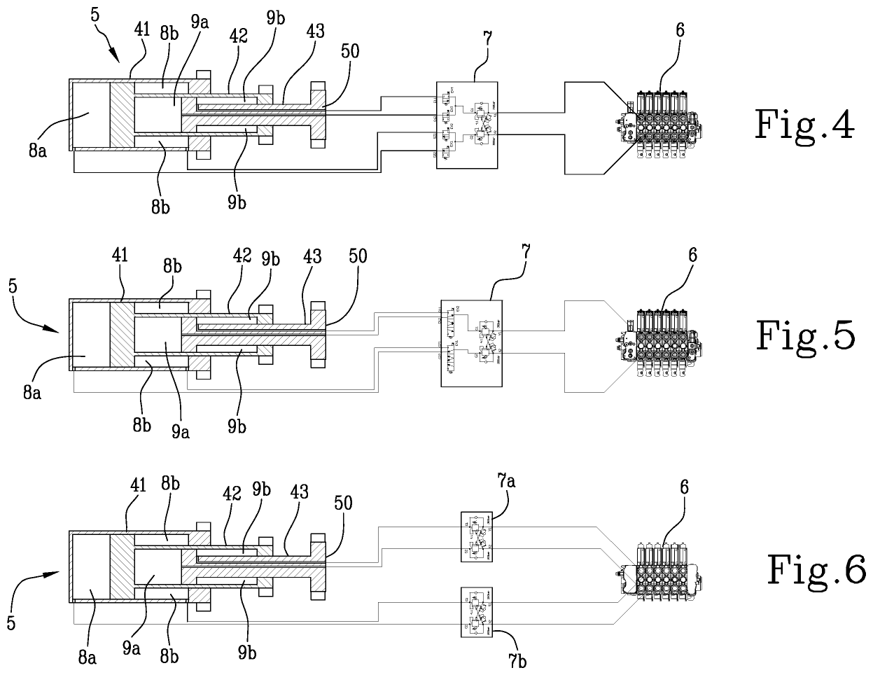

FIGS. 4 to 9 are schematic views of some possible embodiments of telescopic actuators with attached valves contained in the arm according to the invention.

With reference to the accompanying drawings, the numeral 1 denotes in its entirety a telescopic lifting arm which, for simplicity of description, will hereafter be referred to as the arm 1.

The arm 1 proposed is intended to be mounted on self-propelled operating machines 10 such as telescopic handlers (telehandlers), manipulators, forklift trucks, aerial platforms both of the fixed type and of the rotary type, or other similar machines.

In the example shown in FIG. 1, the arm 1 is used in a telescopic handler, that is to say, in a so-called telehandler.

The arm 1 according to the invention is designed for mounting and supporting, at its end, an apparatus for lifting or moving loads, which may comprise a tool, such as a fork, a gripper or the like.

The arm 1 may have, at its end, a coupling device 11, also of known type, which allows the apparatus to be replaced.

The arm 1 according to the invention is designed to be articulated to the frame or to the rotary platform 20 of the machine 10, so as to be able to incline, on the actuation of a hydraulic cylinder or the like, between a lower position, substantially horizontal, and an upper position wherein the arm 1 is close to the vertical.

The arm 1 is extendible and retractable and, more specifically, comprising at least three tubular elements (or “segments”) 21, 22, 23, 24, 25, 26, with a decreasing cross-section and telescopically connected to each other, to define a supporting structure which is designed to move between a retracted configuration (shown in FIG. 1), wherein the tubular elements 21, 22, 23, 24, 25, 26 are inserted one in the other, and an elongated configuration (not illustrated), wherein at least two tubular elements are at least partly extracted (as shown for example in FIG. 2) and preferably completely extracted.

Preferably, the tubular elements 21, 22, 23, 24, 25, 26 are coaxial with each other and designed to translate along the axial direction.

According to the non-limiting embodiment illustrated in the drawings, there is a proximal tubular element 21, on the outside, intended to be directly connected to the frame or to the tower 20, and five “sliding members” 22, 23, 24, 25, 26, that is to say, five extractable tubular elements, slidably inserted in each other.

The proximal tubular element 21 is the “fixed” one, in the sense that it does not slide, and it is the outermost one; the sliding members (that is to say, the tubular elements 22, 23, 24, 25, 26) slide in the longitudinal direction to the arm 1.

In any case, the arm 1 according to the invention comprises three or more tubular elements 21, 22, 23, 24, 25, 26, of which one may be the fixed one and the others may be the sliding members.

Thus, the invention comprises a first sliding member 22, contained at least partly and in a pull-out manner in the fixed segment 21 of the arm 1 and a second sliding member 23, contained at least partly and in a pull-out manner in the first sliding member 22.

The invention may include a third sliding member 24 contained, at least partly and in a pull-out manner in the second sliding member 22; in the version shown in the drawings, there are also a fourth and a fifth sliding members 25, 26.

The telescopic structure described above (hereinafter referred to as “main structure”, for simplicity) is able to support and raise the work equipment and is provided, preferably, for including the extension and retraction mechanisms, as well as the further operating means, such as, for example, the pipes for feeding pressurised oil to the actuators which the equipment is equipped with.

As mentioned above, for simplicity of description, the tubular elements 22, 23, 24, 25, 26 will be associated with an increasing ordinal number, starting from that with the larger cross-section and going towards the distal one, with the smaller cross-section; therefore, the larger sliding member, slidably inserted in the fixed segment (that is, the tubular member 21), will be the first sliding member 22, the further sliding member inserted slidably in the first sliding member will be the second sliding member 23 and so on.

The arm 1 proposed comprises actuator means 4 associated with the tubular elements 21, 22, 23, 24, 25, 26 of the supporting structure.

At least two of the tubular elements 21, 22, 23, 24 25, 26 can be operated independently and simultaneously by the actuator means 4 with different speeds, both different from zero. In other words, the tubular elements are driven by the actuator means in such a way as to move simultaneously but also in such a way that at least two of them move at different speeds.

More specifically, there is at least one proximal tubular element and one distal tubular element which can be operated independently of the actuator means 4, in such a way as to be able to move simultaneously but at different speeds.

For this reason, the tubular elements 21, 22, 23, 24 25, 26 are not driven in sequence and/or at the same speed, but are moved at the same moment at different speeds.

The independent and simultaneous actuation of the tubular elements 21, 22, 23, 24 25, 26 by the actuator means 4 is defined as a simultaneous asynchronous actuation.

The term simultaneous asynchronous actuation means an actuation of the arm 1 wherein the proximal sliding member and one or more distal sliding members (that is, the tubular members 22-26) are moved independently and simultaneously with respect to each other and at different speeds from each other, in such a way that the extension of one tubular member is different from the extension of another as shown for example in FIG. 2. In other words, the actuator means 4 associated with the tubular elements 21, 22, 23, 24, 25, 26 are configured for actuating at least two of the tubular elements 21, 22, 23, 24 25, 26 for pulling them out independently from one other and at different speeds.

Advantageously, the simultaneous asynchronous actuation makes it possible to maximise the load capacity of the operating machine 10 in any geometrical condition of the arm 1.

In other words, actuating the tubular elements 21, 22, 23, 24, 25, 26 independently and simultaneously maintains the centre of gravity (COG) or barycentre of the arm 1 as close as possible to the centre of rotation under all conditions of extension and angle of the arm. More specifically, the centre of rotation corresponds to the axis of rotation of the hinge which connects the arm 1 to the frame. The above-mentioned actuation is guaranteed, as already mentioned, by the actuator means 5 which move the tubular elements 22-26 in such a way that the overall centre of gravity of the arm 1 is as close as possible to the tubular element 21 in such a way as to also prevent possible damage to the tubular elements due to the load.

Advantageously, the asynchronous actuation of at least two of the tubular elements 21, 22, 23, 24 25, 26 therefore allows the maximum performance to be obtained, with the same dimensions of the arm 1.

In other words, there is no need to increase the dimensions or the quality of the material with which the arm 1 is made in order to manage the critical conditions of the mechanics of the arm 1.

According to a possible embodiment, the actuator means 5 are made in the form of a single hydraulic actuator with two independent stages 5.

The hydraulic actuator with two independent stages 5 is provided with at least three hydraulic elements 41, 42, 43 connected to each other telescopically.

Each hydraulic element 41, 42, 43 is connected independently to a respective tubular element 21, 22, 23, 24 25, 26 of the supporting structure. According to the embodiment shown in FIGS. 4, 5, 6, the three hydraulic elements comprise a sleeve 41 (or body) and two hydraulic elements 42, 43 (or sliding members) of a two-stage hydraulic actuator 5, the first and the second being connected to a respective segment 21, 22, 23 of the main structure which contains them.

However, there are possible embodiments of the invention wherein the number of hydraulic elements 42, 43 is greater or less.

According to the example embodiment illustrated in the accompanying drawings, two of the sliding members 22, 23 of the arm 1 are connected to the actuator means 5, whilst the remaining sliding members 24, 25, 26 are connected to a chain member.

In fact, the invention also comprises a motion transmission unit which connects at least two tubular elements 22, 23, 24, 25, 26 and includes one or more flexible and inextensible linear elements (for example chains) and several linkage devices on which the linear elements slide.

The element 3 is designed to cause the sliding out and/or the re-entering of a given tubular member relative to another, following the sliding out/re-entering of the latter.

According to the embodiment wherein the arm 1 comprises five sliding members 22, 23, 24, 25, 26, and the chain unit, the latter may be connected to and act functionally on the three end sliding members 24, 25, 26 of the main structure, which comprise, that is to say, the final or distal segment 26 which supports the apparatus 11.

In detail, one of the rods 42 of the actuator is connected to the above-mentioned fixed segment 21, whilst the other rod 43 and the sleeve 41 are connected, respectively, to the first 22 and to the second sliding member 23.

In this case, the third, the fourth and the fifth sliding members 24, 25, 26 are connected to the above-mentioned chain member.

In more general terms, the invention comprises at least two sliding members actuated by the actuator means 5.

According to the invention, at least the distal sliding member 26 and the sliding member which houses it 25 (the “penultimate” sliding member) are connected to the chain member whilst at least two other sliding members are connected to a respective hydraulic element of the actuator means 5.

Moreover, the proximal tubular element 21 (that is, the fixed segment, in the sense defined above) is connected to an end rod 43 of the actuator means 5, whilst an intermediate tubular element (or “sliding member”) 23 is connected to the sleeve 41.

Returning to a preferred version of the arm 1 proposed, the actuating means 5 are designed to allow the rods 42, 43 (and hence the sliding members) to be extended and retracted in a simultaneous and non-sequential manner. Preferably, the chain member is also designed to produce a simultaneous and non-sequential extension and retraction of the sliding members.

According to another preferred embodiment, shown in FIGS. 7, 8, 9, the actuator means 5 comprise two hydraulic actuators 5a and 5b which are independent of each other.

Each hydraulic actuator 5a and 5b is provided with at least two hydraulic elements 41, 42, 43 connected to each other telescopically.

The hydraulic actuators 5a and 5b and the hydraulic elements 41, 42, 43 are connected independently to a respective tubular element 21, 22, 23, 24 25, 26 of the supporting structure.

Both the embodiments proposed for the actuator means 5 are configured for extending, preferably, a hydraulic element 41, 42, 43 connected or connectable to a distal pull-out element, for example the tubular element 26, at a speed greater than a hydraulic element 41, 42, 43 connected or connectable to said proximal tubular element 22 is extended.

In other words, the invention may be actuated by a hydraulic actuator 5 with two independent stages or by two independent hydraulic actuators 5a and 5b which are actuated simultaneously but at different speeds.

More specifically, the hydraulic element 41, 42, 43 coupled to the distal sliding members extends with a speed greater than the extension of the actuator element 41, 42, 43 which, on the other hand, is coupled to the proximal sliding member.

Advantageously, under equal conditions of weight of the load, this may be carried further, or the load may be increased under equal conditions of safety against the risk of overturning of the machine.

The greater speed of extension of the hydraulic element 41, 42, 43 coupled to the distal sliding members advantageously allows a barycentre of the arm 1 to be more retracted (closer to the hinge of the arm) with respect to a synchronous actuation of the arm 1.

At the same time, through the simultaneous asynchronous actuation, it is possible to obtain a balanced distribution of the mechanical stresses on the tubular elements 21, 22, 23, 24, 25, 26.

In other words, advantageously, the extension of the lighter sliding members 23, 24, 25, 26, that is to say, the distal ones and the less resistant ones, is prevented from receiving the majority of the mechanical stresses, which, on the contrary, will also be discharged on the heavier sliding members, that is to say, the proximal ones, and on the fixed segment 21.

According to a possible embodiment, shown schematically in FIGS. 4, 5, 6, 7, 8, 9, the arm 1 comprises a main valve 6 and a control valve 7.

The main valve 6 is connected or connectable to the actuator means 5 for supplying the actuator means.

In other words, the main valve 6 is able to control the two stage-actuator 5 or the two independent hydraulic actuators 5a and 5b.

The control valve 7, interposed between the main valve 6 and the actuator means 5, is configured for actuating simultaneously and at different speeds each hydraulic element 41, 42, 43 of the actuator means 5.

Preferably, the control valve 7 is designed to receive oil from a single section of the main valve 6 and control the delivery and the return of the oil in one or more chambers 8a, 8b, 9a, 9b of the actuator means 5.

The chambers 8a, 8b, 9a, 9b are used for the pulling out (8a and 9a) and for the re-entry (8b, 9b) of respective hydraulic elements 41, 42, 43.

In other words, the actuator means 5 include a sleeve 41 in which is defined a first chamber 8a with variable volume designed to contain operating fluid, in particular incompressible, preferably oil.

Inside the sleeve and the other hydraulic elements 42, 43 there is, preferably in a central position, an extendible channel 50 (for example telescopic).

The invention comprises in the case of the two-stage hydraulic actuator 5 a second chamber 9a, with a variable volume, defined inside the hydraulic element 42 and a first re-entry chamber 8b, with a variable volume, defined between the hydraulic element 41 and 42.

The possible structural configuration, with concentricity of the chambers 8a, 8b, 9a, 9b described, makes it possible to obtain a dimensional advantage. In effect, by exploiting the empty spaces, for example using the first chamber 8 as a guide of the chamber 9, it is possible to reduce the overall size of these elements whilst keeping independent the actuation of each hydraulic element 41, 42, 43.

More specifically, the first re-entry chamber 8b may be defined between the side walls of the sleeve 41 and the hydraulic element 42.

The first activation chamber 8a and the second activation chamber 9a allow, independently of each other, the reciprocal extension and/or re-entry of the sleeve 41 and of the hydraulic element 42, following the inlet and/or outlet of an operating fluid through the telescopic channel 50.

It should be noted that, preferably, the hydraulic elements 41, 42, 43 are hollow elements substantially cylindrical in shape.

The invention shown in FIGS. 4, 5, 6 also comprises a second re-entry chamber 9b defined between the hydraulic elements 42 and 43.

When the pressurised fluid enters the first activation chamber 8a, the hydraulic element 41 slides in extension relative to the hydraulic element 42.

Similarly, when the second activation chamber 9a is filled, the hydraulic element 42 slides in extension relative to the hydraulic element 43.

In this way, the hydraulic actuator 5 has an elongation in two stages.

The process for actuating the two-stage hydraulic actuator 5a and 5b solution is as described, with the difference that each hydraulic actuator 5a and 5b preferably has a single activation chamber 8a or 9a and a single re-entry chamber 8b or 9b.

More specifically, the process will comprise for both the actuators 5a and 5b an entry of pressurised fluid in the activation chamber 8a or 9a with subsequent sliding of the hydraulic element 41 relative to the hydraulic element 42 and passage of fluid from the re-entry chamber 8b or 9b towards the outside.

According to a possible embodiment, for each chamber 8a, 8b, 9a, 9b there is a proportional valve included in the control valve 7.

FIGS. 4 and 7 show schematic examples of the control valve comprising the proportional valves.

According to this embodiment illustrated, only one section of the main valve 6 is used for conveying the oil in the control valve 7, which has four proportional valves which manage the supply and return of the four chambers 8a, 8b, 9a, 9b.

Alternatively, the control valve 7 may comprise a valve for dividing the flow for each pair of chambers 8a, 8b, 9a, 9b of the actuator means 5.

The term “pair of chambers” 8a, 8b, 9a, 9b means two chambers of a same hydraulic element 41, 42, 43.

For example, the pair of chambers 8a and 8b of the hydraulic element 41 and/or the pair of chambers 9a and 9b of the hydraulic element 42 of the same hydraulic actuator 5, shown in FIGS. 4, 5, 6.

Alternatively, the term “pair of chambers” may mean the pair of chambers 8a and 8b of the first hydraulic actuator 5a and/or the pair of chambers 9a and 9b of the second hydraulic actuator 5b, shown in FIGS. 7, 8, 9.

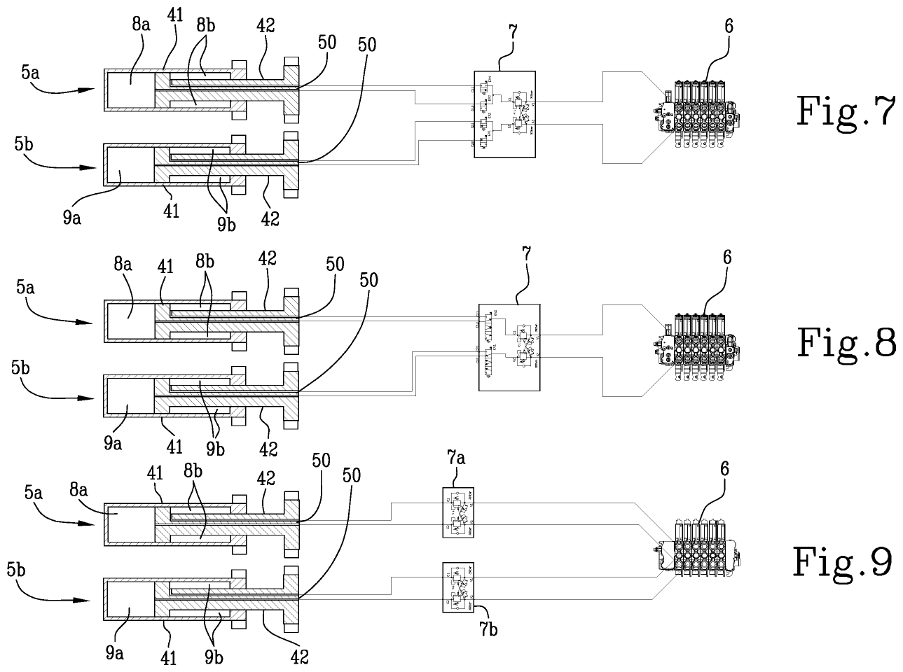

This solution, shown in FIGS. 7 and 8, uses a single section of the main valve 6 for conveying the oil in the control valve 7 which comprises two valves for dividing the flow which manage the supply and return of the four chambers 8a, 8b, 9a, 9b.

According to another possible embodiment, the control valve 7 is defined by two block valves 7a and 7b interposed between the main valve 6 and the actuator means 5.

Each of the block valves 7a and 7b is connected to two sections of the main valve 6 in order to control independently each hydraulic element 41, 42, 43. In other words, two sections of the main valve 6 are used, in such a way as to have upstream a complete independent control of the hydraulic elements 41, 42, 43.

FIGS. 6 and 9 schematically show the solution of the control valve 7 provided with block valves 7a and 7b.

The arm 1 may also comprise a control unit configured for adjusting the main valve 6 and/or the control valve 7 in such a way as to move the hydraulic elements 41, 42 and 43.

The aim of this adjustment by the control unit is to define a specific operational positioning of the tubular elements 21, 22, 23, 24, 25, 26.

In other words, the control unit intervenes on the main valve 6 and on the control valve 7 so as to position the hydraulic elements 41, 42, 43 in positions compatible with a load diagram of the machine.

In fact, the specific operating positioning will be different depending on how extended the arm 1 will be and the load which it will have to support.

The load diagram therefore establishes the positions of the space in which a certain load can be carried, that is to say, a certain weight, without the risk of overturning of the operating machine 10 occurring.

According to a further embodiment, the arm 1 comprises at least two sliding sensors which are independent from one another and connected to the control unit.

The sliding sensors are configured for measuring an extension of the hydraulic elements 41, 42 and 43 and for sending a checking signal to the control unit identifying a correct extension of the hydraulic elements 41, 42, 43, that is to say, the tubular elements 21, 22, 23, 24, 25, 26 actuated in an asynchronous fashion by the latter.

1. A telescopic lifting arm (1) for self-propelled operating machines (10), the arm comprising at least three tubular elements (21, 22, 23, 24, 25, 26), with a decreasing cross-section and telescopically connected to each other to define a supporting structure, designed to move between a retracted configuration wherein said tubular elements (21, 22, 23, 24, 25, 26) are inserted one in the other and an elongated configuration wherein at least two tubular elements are at least partly extracted, the arm (1) comprises actuator means (5) associated with said tubular elements (21, 22, 23, 24, 25, 26) and configured for actuating at least two of said tubular elements (21, 22, 23, 24 25, 26) for pulling them out independently from one another and with different speeds.

2. The arm (1) according to claim 1, wherein said actuator means (5) are made in the form of a single hydraulic actuator with two independent stages (5) equipped with at least three hydraulic elements (41, 42, 43) connected to each other telescopically, each of said hydraulic elements (41, 42, 43) is connected independently to a respective tubular element (21, 22, 23, 24 25, 26) of the supporting structure.

3. The arm (1) according to claim 1, comprising two hydraulic actuators which are independent of each other (5a, 5b) and wherein each hydraulic actuator (5a, 5b) is equipped with at least two hydraulic elements (41, 42, 43) connected to each other telescopically, each of said hydraulic actuators (5a, 5b) and each hydraulic element (41, 42, 43) is connected independently to a respective tubular element (21, 22, 23, 24 25, 26) of the supporting structure.

4. The arm (1) according to claim 2, wherein said tubular elements (21, 22, 23, 24, 25, 26) include a proximal tubular element, designed to be hinged to a frame or to a tower (20) of said operating machine (10), and at least two pull-out elements consisting of as many tubular elements (21, 22, 23, 24, 25, 26) of the supporting structure, a distal pull-out element (26) being designed to support a work equipment and being removable and able to be housed at least partly in another pull-out element (25), at least two pull-out elements (22, 23) being connected to a respective hydraulic element (41, 42, 43) of the actuator means (5).

5. The arm (1) according to claim 4, wherein said actuator means (5) are configured for extending a hydraulic element (41, 42, 43) connected or connectable to a distal pull-out element (26) at a greater speed with which is extended a hydraulic element (41, 42, 43) connected or connectable to said proximal tubular element (21).

6. The arm (1) according to claim 2, comprising a main valve (6) connected or connectable to said actuator means (5) for supplying oil of said actuator means (5) and a control valve (7) interposed between said main valve (6) and said actuator means (5), said control valve (7) being configured to actuate simultaneously and at different speeds each hydraulic element (41, 42, 43) of said actuator means (5).

7. The arm (1) according to claim 6, wherein said control valve (7) is designed to receive oil from a single section of said main valve (6) and to control the delivery and the return of said oil in one or more chambers (8a, 8b, 9a, 9b) of said actuator means (5) used for the sliding and the return of respective hydraulic elements (41, 42, 43).

8. The arm (1) according to claim 7, wherein said control valve (7) comprises, for each chamber (8a, 8b, 9a, 9b) of said actuator means (5), a proportional valve.

9. The arm (1) according to claim 7, wherein said control valve (7) comprises a valve for dividing the flow for each pair of chambers (8a, 8b, 9a, 9b) of said actuator means (5), each pair of chambers (8a, 8b, 9a, 9b) being defined by two chambers of a same hydraulic element (41, 42, 43).

10. The arm (1) according to claim 7, wherein said control valve (7) is defined by two block valves (7a, 7b) interposed between said main valve (6) and said actuator means (5); each of said block valves (7a, 7b) is connected to a respective section of said main valve (6) for controlling independently each hydraulic element (41, 42, 43).

11. The arm (1) according to claim 6, comprising a control unit configured for adjusting said main valve (6) and/or said control valve (7) in such a way as to move said hydraulic elements (41, 42, 43) in such a way as to define a specific operating positioning of said tubular elements (21, 22, 23, 24, 25, 26).

12. The arm (1) according to claim 11, comprising at least two sliding sensors independent of one another and connected to said control unit; said sliding sensors being configured to measure an extension of said hydraulic elements (41, 42, 43) and to send a checking signal to said control unit identifying an extension of the hydraulic elements (41, 42, 43) of said tubular elements (21, 22, 23, 24, 25, 26).
